(19) United States
(12) Patent Application Publication
(10) Pub. No.: US 2013/0275436 A1
(43) Pub. Date: Oct. 17, 2013

(54) PSEUDO-DOCUMENTS TO FACILITATE DATA DISCOVERY

(71) Applicants: Surajit Chaudhuri, Redmond, WA (US); Lev Novik, Bellevue, WA (US); John C. Platt, Bellevue, WA (US)

(72) Inventors: Surajit Chaudhuri, Redmond, WA (US); Lev Novik, Bellevue, WA (US); John C. Platt, Bellevue, WA (US)

(73) Assignee: Microsoft Corporation, Redmond, WA (US)

(21) Appl. No.: 13/444,717

(22) Filed: Apr. 11, 2012

(51) Int. Cl. G06F 17/30

(52) U.S. Cl. 707/742; 707/750; 707/E17.086; 707/E17.084

(57) ABSTRACT

Various embodiments promote the discoverability of data that can be contained within a database. In one or more embodiments, data within a database is organized in a structure having a schema. The structure and data can be processed in a manner that renders one or more pseudo-documents each of which constitutes a sub-structure that can be indexed. Once produced and indexed, the pseudo-documents constitute a set of searchable objects each of which relationally points back to its associated structure within the database. Searches can now be performed against the pseudo-documents which, in turn, returns a set of search results. The set of search results can include multiple sub-sets of pseudo-documents, each sub-set of which is associated with a different structure.

### BACKGROUND

Databases are starting to be treated as objects to be searched, where the searcher may not yet understand the schema or the data within the database. Given the vast numbers of databases and the rate at which these numbers are increasing, as well as the rate at which data contained in these databases are growing, discovering relevant data can be a daunting task not only for those who are familiar with a database and its schema, but more so for those who are not familiar with a database and its schema.

### SUMMARY

This Summary is provided to introduce a selection of concepts in a simplified form that are further described below in the Detailed Description. This Summary is not intended to identify key features or essential features of the claimed subject matter.

Various embodiments promote the discoverability of data that can be contained within a database. In one or more embodiments, data within a database is organized in a structure having a schema. The structure and data can be processed in a manner that renders one or more pseudo-documents each of which constitutes a sub-structure that can be indexed. Any suitable criteria can be used to process the structure and data of the database to create the pseudo-documents. In some embodiments, processing can include running queries, such as SQL queries, against the database or other function calls to produce the pseudo-documents.

Once produced and indexed, the pseudo-documents constitute a set of searchable objects each of which relationally points back to its associated structure within the database. Searches can now be performed against the pseudo-documents which, in turn, returns a set of search results. The set of search results defines a collection of pseudo-documents, and each pseudo-document relationally points back to its associated structure.

Properties and characteristics of the collection of pseudo-documents can be used to ascertain the relevance of their associated structures relative to the search that was performed to produce the collection. Once the relevance of the associated structures is ascertained, one or more associated structures within the database or databases can be identified as being more likely to be of use to a particular search user.

Pseudo-documents can serve to abstract away the schemas of individual structures within the database and can promote easier, more simplified search paradigms to facilitate discovery of data within a database.

### BRIEF DESCRIPTION OF THE DRAWINGS

The same numbers are used throughout the drawings to reference like features.

FIG. 1 illustrates an example operating environment in accordance with one or more embodiments.

FIG. 2 illustrates an example operating environment in accordance with one or more embodiments.

FIG. 3 illustrates an example operating environment in accordance with one or more embodiments.

FIG. 4 illustrates example data structures and pseudo-documents in accordance with one or more embodiments.

FIG. 5 illustrates an environment in which pseudo-documents can be searched in accordance with one or more embodiments.

FIG. 6 is a flow diagram that describes steps in a method in accordance with one or more embodiments.

FIG. 7 is a flow diagram that describes steps in a method in accordance with one or more embodiments.

FIG. 8 illustrates an example system in accordance with one or more embodiments.

FIG. 9 illustrates an example device in accordance with one or more embodiments.

### DETAILED DESCRIPTION

### Overview

Various embodiments promote the discoverability of data that can be contained within a database. In one or more embodiments, data within a database is organized in a structure having a schema. The structure and data can be processed in a manner that renders one or more pseudo-documents each of which constitutes a sub-structure that can be indexed. Any suitable criteria can be used to process the structure and data of the database to create the pseudo-documents. In some embodiments, processing can include running queries, such as SQL queries, against the database or other function calls to produce the pseudo-documents.

Once produced and indexed, the pseudo-documents constitute a set of searchable objects each of which relationally points back to its associated structure within the database. Searches can now be performed against the pseudo-documents which, in turn, returns a set of search results. The set of search results defines a collection of pseudo-documents, and each pseudo-document relationally points back to its associated structure.

Properties and characteristics of the collection of pseudo-documents can be used to ascertain the relevance of their associated structures relative to the search that was performed to produce the collection. Once the relevance of the associated structures is ascertained, one or more associated structures within the database or databases can be identified as being more likely to be of use to a particular search user. Pseudo-documents can serve to abstract away the schemas of individual structures within the database and can promote easier, more simplified search paradigms to facilitate discovery of data within a database.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

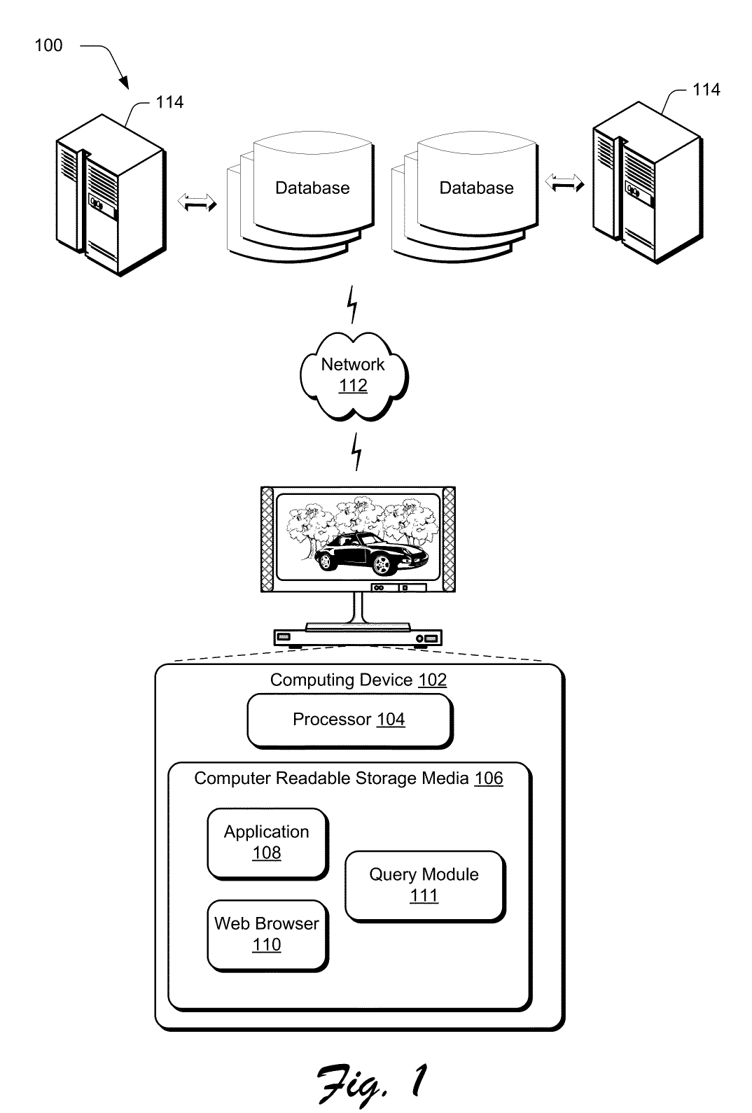

FIG. 1 illustrates an operating environment in accordance with one or more embodiments, generally at 100. Environment 100 includes a computing device 102 in the form of a local client machine having one or more processors 104, one or more computer-readable storage media 106, one or more applications 108 that resides on the computer-readable storage media and which are executable by the processor 104. Computing device 102 also includes a web browser 110 and a query module 111. Module 111 can reside as a separate component that is utilized by applications 108 and web browser 110. Alternately, module 111 can be integrated with applications 108 and/or web browser 110 to enable searches of pseudo-documents to be conducted as described below.

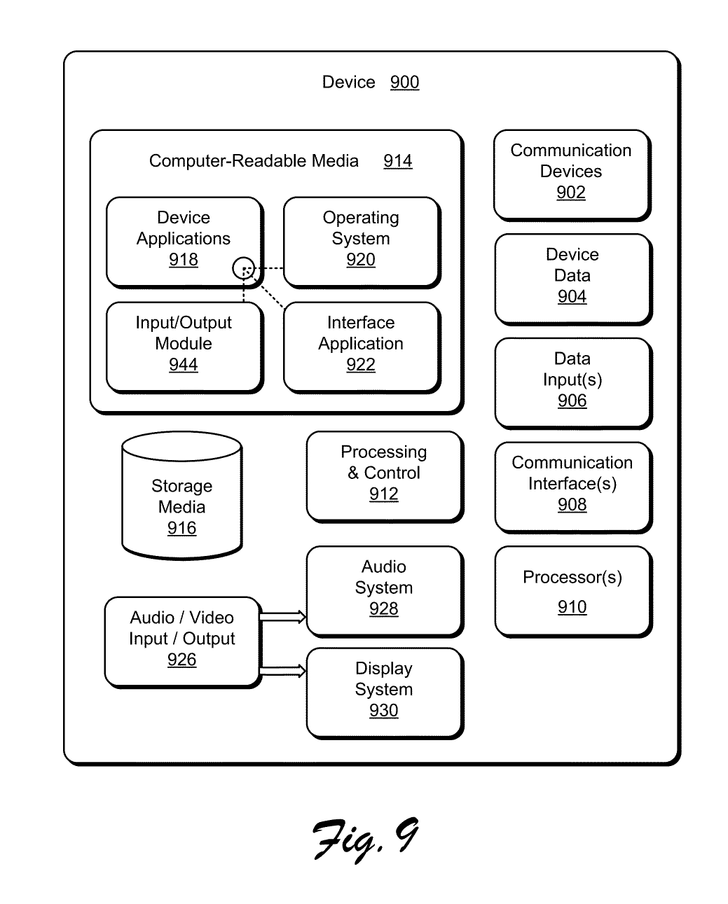

Computing device 102 can be embodied as any suitable computing device such as, by way of example and not limitation, a desktop computer, a portable computer, a handheld computer such as a personal digital assistant (PDA), mobile phone, television, tablet computer, and the like. One of a variety of different examples of a computing device 102 is shown and described below in FIGS. 8 and 9.

Applications 108 can include any suitable type of applications. The web browser 110 is configured to navigate via the network 112. Although the network 112 is illustrated as the Internet, the network may assume a wide variety of configurations. For example, the network 112 may include a wide area network (WAN), a local area network (LAN), a wireless network, a public telephone network, an intranet, and so on. Further, although a single network 112 is shown, the network 112 may be configured to include multiple networks.

The browser may be configured to navigate via the network 112 to interact with content available from one or more servers 114, such as web servers, as well as communicate data to the one or more servers 114, e.g., perform downloads and uploads. The servers 114 may be configured to provide one or more services that are accessible via the network 112 and can include one or more databases that maintain data (such as structured data and associated metadata) that can be accessed by computing device 102. The structured data within the database can be structured in any suitable way including, by way of example and not limitation, relational structures such as tables and the like. The tables include rows and columns which can be designated in any suitable way. Intersections of rows and columns defined cells which, in turn, can include searchable data.

The servers 114 can include a data analyzer and an index module that operates to provide searchable pseudo-documents as described below in more detail. As noted above, the servers can provide various services including, by way of example and not limitation, map services, email, web pages, photo sharing sites, social networks, content sharing services, media streaming services, data retrieval and/or displaying services and so on. Data associated with these services can be organized and maintained within associated databases as structured data and associated metadata. Metadata can be provided by the creator or maintainer of the database to facilitate searches. Alternately or additionally, the metadata can include implicit metadata that is developed by third parties other than creators or maintainers of the database and subsequently added to the database to provide a collective window into the content of the database. For example, as end-users interact with data of a particular database, the end-users can cause so-called implicit metadata to be added to the database that describes some characteristics or properties of the data.

Searchable pseudo-documents promote the discoverability of data that can be contained within a database while, at the same time, abstract away the structure and/or schema of the data that appears in the database. In one or more embodiments, data within a database is organized in a structure having a schema. Any suitable structure and schema can be utilized. For example, any suitable relational structure such as tables and the like can be utilized to organize and maintain data that appears within the database. The structure and data can be processed in a manner that renders one or more pseudo-documents each of which constitutes a sub-structure that can be indexed. Any suitable criteria can be used to process the structure and data of the database to create the pseudo-documents. In some embodiments, processing can include running queries, such as SQL queries, against the database or other function calls to produce the pseudo-documents. Indexing can take place in any suitable manner. For example, in at least some embodiments, the pseudo-documents can be indexed by creating an inverted index which stores a mapping of words, terms, numbers or other information to their associated pseudo-documents. An inverted index can allow for fast full text searches, as will be appreciated by the skilled artisan.

Once produced and indexed, the pseudo-documents constitute a set of searchable objects each of which relationally points back to its associated structure within the database. Searches can now be performed against the pseudo-documents which, in turn, returns a set of search results. The set of search results defines a collection of pseudo-documents, and each pseudo-document relationally points back to its associated structure. For example, a particular database may contain thousands of tables that are utilized to organize data. Each of these tables can have its own set of pseudo-documents which constitute a set of searchable objects for a particular table. By conducting searches on the pseudo-documents, pseudo-documents can be developed for respective tables.

Properties and characteristics of the collection of pseudo-documents can be used to ascertain the relevance of their associated structures, e.g. table, relative to the search that was performed to produce the collection. Once the relevance of the associated structures, e.g., table, is ascertained, one or more associated structures within the database or databases can be identified as being more likely to be of use to a particular search user.

Pseudo-documents thusly serve to abstract away the schemas of individual structures within the database and can promote easier, more simplified search paradigms to facilitate discovery of data within a database.

One or more of the applications 108 of the computing device may also be configured to access the network 112, e.g., directly themselves and/or through the browser. For example, one or more of the applications 108 may be configured to communicate messages, such as email, instant messages, and so on. In additional examples, an application 108, for instance, may be configured to access a social network, obtain weather updates, interact with a bookstore service implemented by one or more of the web servers 114, support word processing, provide spreadsheet functionality, support creation and output of presentations, searching pseudo-documents, and so on.

Thus, applications 108 may also be configured for a variety of functionality that may involve direct or indirect network 112 access. For instance, the applications 108 may include configuration settings and other data that may be leveraged locally by the application 108 as well as synchronized with applications that are executed on another computing device. In this way, these settings may be shared by the devices. A variety of other instances are also contemplated. Thus, the computing device 102 may interact with content in a variety of ways from a variety of different sources.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

For example, the computing device 102 may also include an entity (e.g., software) that causes hardware or virtual machines of the computing device 102 to perform operations, e.g., processors, functional blocks, and so on. For example, the computing device 102 may include a computer-readable medium that may be configured to maintain instructions that cause the computing device, and more particularly the operating system and associated hardware of the computing device 102 to perform operations. Thus, the instructions function to configure the operating system and associated hardware to perform the operations and in this way result in transformation of the operating system and associated hardware to perform functions. The instructions may be provided by the computer-readable medium to the computing device 102 through a variety of different configurations.

One such configuration of a computer-readable medium is signal bearing medium and thus is configured to transmit the instructions (e.g., as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

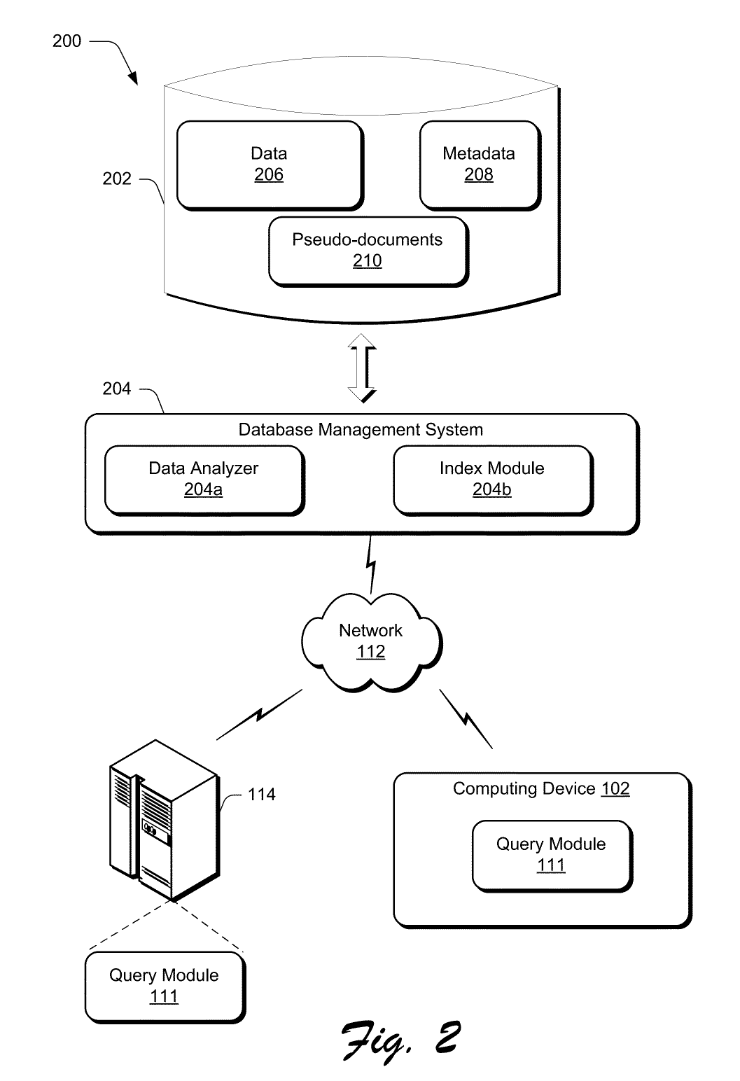

FIG. 2 illustrates, generally at 200, a slightly different view of the operating environment of FIG. 1 wherein like numerals depict like components. In this example, environment 200 includes a database 202 and a database management system 204. The database management system includes one or more computer-readable storage media and computer-readable instructions which implement database management techniques to manage the database and their associated data. As such, the database management system 204 includes one or more software programs that control the organization, storage, management, and retrieval of data within the database 202.

In the illustrated and described embodiment, the database includes data 206 which can be structured in any suitable way, metadata 208 associated with data 206 and pseudo-documents 210 associated with data 206. Database management system 204 includes a data analyzer 204a and an index module 204b. Data analyzer 204a is representative of functionality that analyzes data 206 and associated metadata 208 to produce pseudo-documents 210. The pseudo-documents 210 can then be indexed using index module 204b in any suitable way. For example, the index module 204b can process the pseudo-documents 210 to index them in a manner that provides keywords or strings that are searchable through, for example, an inverted index. Accordingly, when a searcher types in a set of query terms, using for example query module 111 (which may reside on a server 114 and/or an end user's computing device 102), a search engine can use the index to compare the keywords or strings within the pseudo-documents 210 to the received query terms. Based on a returned subset of pseudo-documents, this can allow relevant structured data within database 200 to rank more highly within the returned results. Any suitable type of indexing and ranking approaches can be used, as will be appreciated by the skilled artisan.

Having considered an example operating environment, consider now a discussion of how pseudo-documents can be created and subsequently used in accordance with one or more embodiments.

Creating Pseudo-Documents

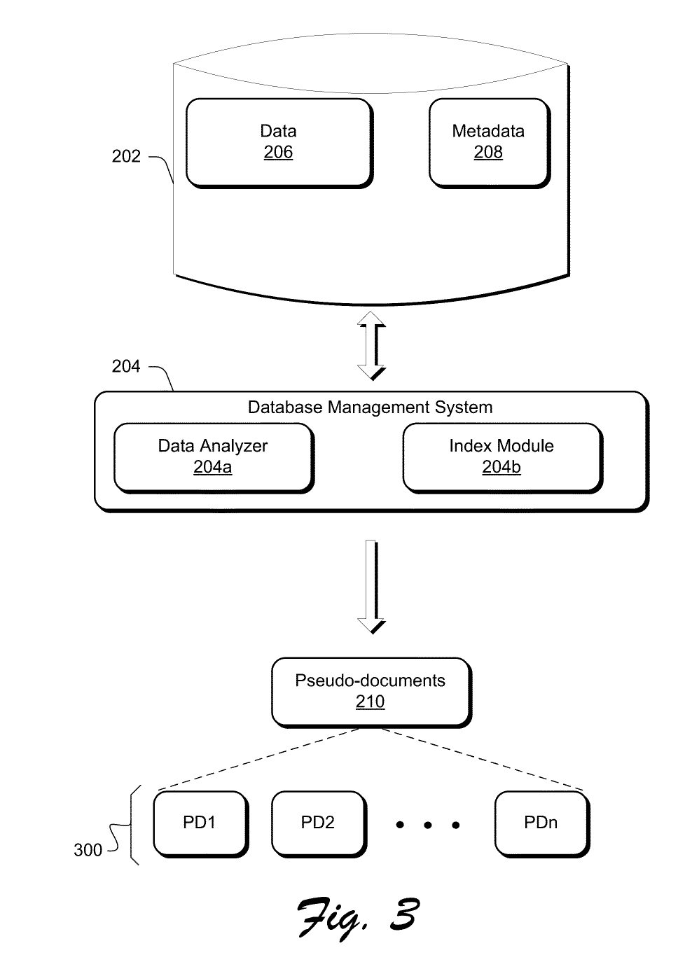

FIG. 3 illustrates database 202 including data 206 and metadata 208 prior to creation of pseudo-documents associated with data 206. In the illustrated and described embodiment, and as noted above, data 206 constitutes structured data that can be structured in any suitable way. One way of structuring such data is to organize the data in terms of relational tables having rows and columns. Other structures can be utilized without departing from the spirit and scope of the claimed subject matter.

In one or more embodiments, a decision can first be made as to which types of pseudo-documents should be created for any particular collection of structured data. This decision can be made based, at least in part, on the types of data comprising data 206, the associated metadata 208, the content of the data itself, likely or actual uses of the data based on its nature, the output of searches that might be conducted on the data 206, and the like. With respect to types of data comprising data 206, consider the following. Within a particular data structure, certain types of data may be perceived to be more important or useful. In these instances, the decision can be made to produce pseudo-documents which more heavily leverage these certain types of data. With respect to the actual content of the data driving a decision to create particular pseudo-documents, consider the following. In certain instances, the content of the data may have certain contextual relevance when considered alone or in combination with other data contained in a particular data structure. In these instances, a decision to create pseudo-documents can leverage the contextual relevance of the data's content when viewed alone, or in combination with other data appearing in the data structure. With respect to likely or actual uses of data, consider the following. In many instances, the very nature of data can drive the likely or actual uses of the data. For example, data related to pricing information of certain products can typically be used in scenarios including marketing scenarios, product price point scenarios, and the like. Given these particular scenarios, decisions can be made to produce pseudo-documents that leverage the likely or actual use of the data. With respect to the output of searches that might be conducted on data of the data structure, consider the following. Given a set of data within a database, one can analyze the data and ascertain how the data might be searched and what the output of such searches may look like. Based on a consideration of what the output of a particular search of a data structure may look like or contain, pseudo-documents can be produced that capture or otherwise embody characteristics and properties of such output. Considering these and other factors, the data analyzer 204a can execute multiple queries, such as SQL queries, function calls, and the like to produce multiple pseudo-documents 210. Each pseudo-document represents a sub-structure of the data structure that was queried. For example, if the data structure that was queried constitutes a table, pseudo-documents might be produced that correspond to individual columns, individual rows, individual cells spread across different columns and/or rows, content contained in tables that are relationally associated with the table that was queried, and the like. Each of these individual pseudo-documents constitutes a searchable object. For any one particular data structure, e.g., table, multiple different pseudo-documents can be produced. Collectively, the multiple different pseudo-documents constitute a set of searchable objects. For example, if a table contains data associated with countries of the world identified by country ID, the data analyzer 204a might conduct the first query directed to identifying data associated with country ID 43. Alternately or additionally, a query can be directed to returning a partition of the table based on this country ID. Based on the queries conducted by data analyzer 204a, multiple different pseudo-documents, here represented by PD1, PD2 . . . PDn, can be produced which capture different characteristics and properties of the structured data comprising data 206. The individual pseudo-documents can then be indexed by index module 204b in any suitable way. The indexed collection of pseudo-documents constitutes a set of searchable objects 300 which can be stored in database 202. In the illustrated and described embodiment, each pseudo-document includes a pointer back to its original structured data, e.g. table.

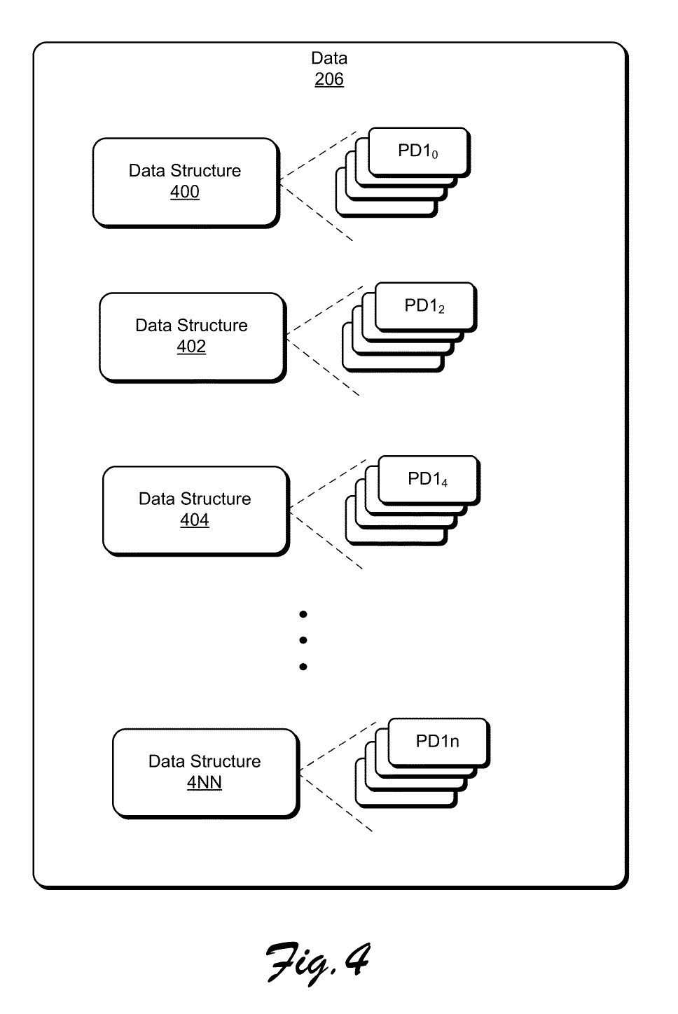

As an example, consider FIG. 4. There, after having been processed by data analyzer 204a and index module 204b (FIG. 3), data 206 from database 202 (FIG. 3) is shown to include multiple data structures, here represented as data structures 400, 402, 404, . . . 4NN. Each of the individual data structures can comprise any suitably-configured structure of data such as a relational structure, table, and the like. Each data structure includes its own collection of pseudo-documents shown just to the right of each data structure. For example, data structure 400 includes a collection of pseudo-documents that starts with a first pseudo-document designated PD10, and so on.

Having created the pseudo-documents as described above for each of the particular data structures, consideration can now be given to how the pseudo-documents can be used.

Using Pseudo-Documents

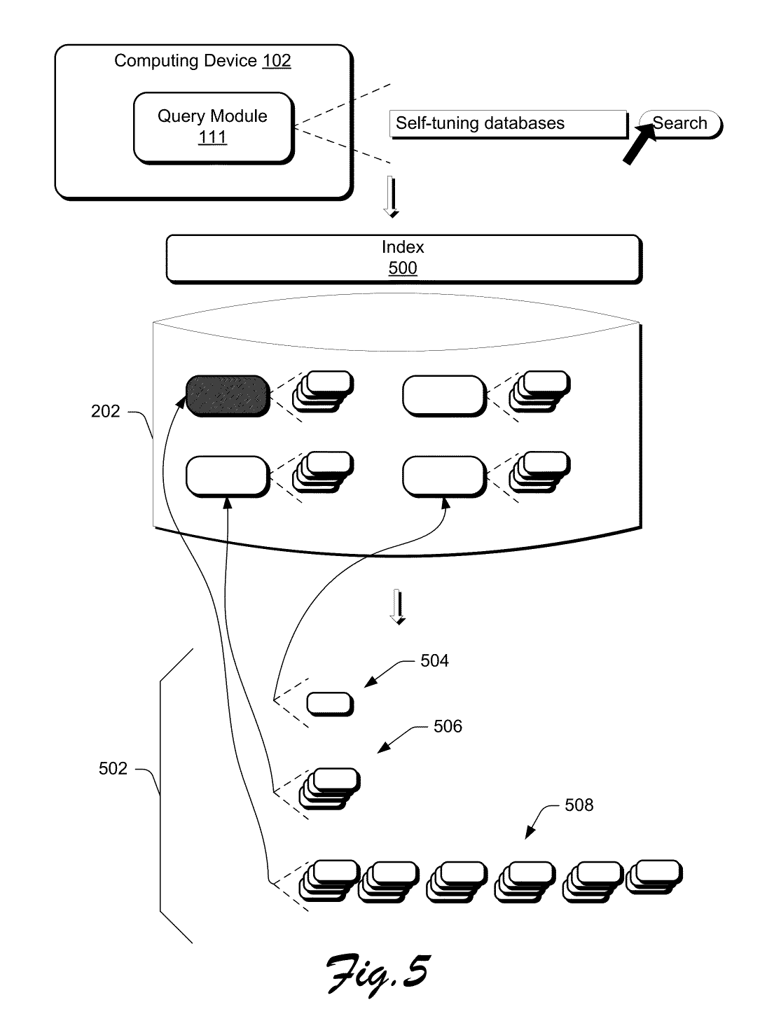

FIG. 5 illustrates a system in which a computing device 102, including query module 111 presents a user interface that enables a user to enter a search term. In this particular example, the search term entered by the user is “self-tuning databases”. This entered search term forms a query that is conducted against the pseudo-documents that appear in database 202 using a suitably configured index 500, such as an inverted index. Specifically, database 202 includes multiple different data structures (here represented by the larger rectangles) each having their own collection of pseudo-documents (here represented by the smaller rectangles). The indexed pseudo-documents are searched, using the search term entered by the user, and a result set 502 is returned that includes multiple different pseudo-documents, individual collections of which are respectively associated with a data structure. Specifically, each pseudo-document relationally points back to one or more structures with which it is associated. In this particular example, a first data structure is associated with a single pseudo-document 504, a second data structure is associated with four pseudo-documents 506, and a third data structure is associated with 23 pseudo-documents 508 that match or are otherwise related to the search term entered by the user. Recall that each of the pseudo-documents includes a pointer back to its associated data structure, here diagrammatically represented by the line that points back to an associated data structure. Assume in this example that each data structure has 30 associated pseudo-documents. By virtue of the fact that 23 pseudo-documents were returned for the third data structure, one can surmise that the third data structure is likely to be more germane to the user's entered the search term than the first and second data structures. Based on this, a decision can be made that the third data structure is very central to the user's search term and thus, a level of importance can be assigned to it for subsequent use. Other criteria can be used to rank data structures in view of the collection of pseudo-documents that are returned from the user's search. For example, text-based scoring can be used to calculate a score for each pseudo-document based upon the user's search terms. Such text-based scoring can take into account the context in which certain terms are used, as well as locational proximity to other search terms, and the like. Based on the scores for the pseudo-documents, particular associated data structures can be identified. Alternately or additionally, techniques based on static ranking can be utilized to calculate a score for each pseudo-document. For example, for certain types of pseudo-documents, an associated static ranking factor can be utilized that increases the importance of those types of documents in the search results. Based on the scores for the pseudo-documents, particular associated data structures can be identified. Alternatively or additionally, custom dictionaries can be utilized to influence how pseudo-documents are ranked within the search results. Alternately or additionally, pseudo-documents can be ranked based upon particular patterns that might occur within the pseudo-documents. For example, a particular pseudo-document's ranking might be increased or decreased based upon the occurrence of certain URI patterns. Alternately or additionally, pseudo-documents can be ranked based upon their temporal importance to other pseudo-documents (which may or may not point back to the same data structure) that might be returned in a search. For example, a temporal ranking system can collect link information or snapshots indicating links between pseudo-documents at various snapshot times. The ranking system can calculate a current temporal importance of a document by factoring in the current importance of the document derived from the current snapshot and the historical importance of the document derived from past snapshots. Based on the scores for the pseudo-documents, however, generated, particular associated data structures can be identified. Alternately or additionally, various frequency-based techniques can be utilized to rank pseudo-documents. For example, the frequency at which a pseudo-document is returned for particular searches can influence its ranking. Additionally, the frequency at which certain pseudo-documents are returned together can influence their ranking. For example, two or three pseudo-documents that are frequently returned together can rank higher than other pseudo-documents which are not returned frequently together.

It is to be appreciated and understood that pseudo-documents and their associated data structures can be ranked in any suitable way without departing from the spirit and scope of the claimed subject matter.

In this particular example, it is to be appreciated and understood, that the search entered by the user is not a structured search in terms of a SQL query or other similar query. Rather, a simple keyword search has been entered and, by virtue of the abstraction provided by the pseudo-documents, a relevant data structure or structures can be identified which can then be the subject of further searches. Thus, searchers can quickly and efficiently identify information and data that is useful to them without the need to formulate complex structured searches.

Example Methods

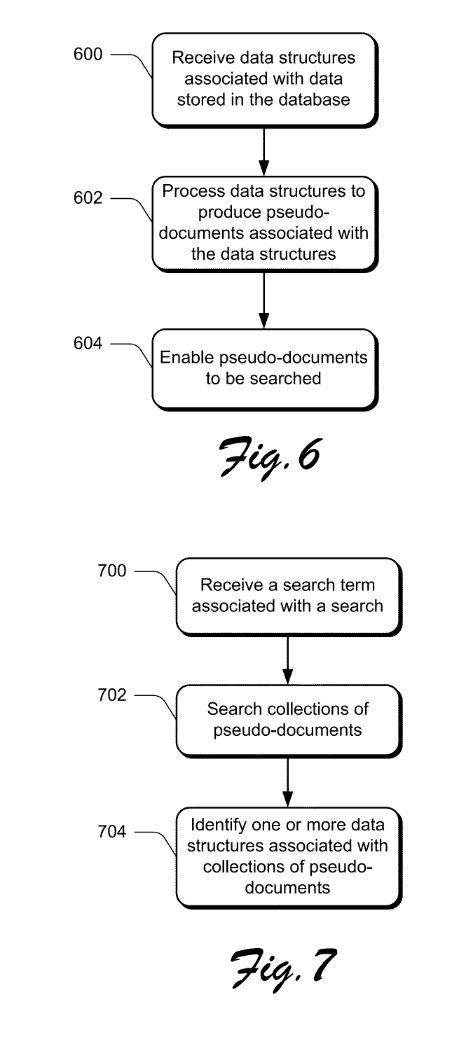

FIG. 6 is a flow diagram that describes steps in a method in which pseudo-documents can be created in accordance with one or more embodiments. The method can be implemented in connection with any suitable hardware, software, firmware, or combination thereof. In at least some embodiments, the method can be implemented by a suitably-configured data analyzer and index module, such as the ones described above.

Step 600 receives data structures associated with data stored in a database. Any suitable type of data structure can be utilized. In at least some embodiments, data structures reside in the form of tables, although other data structures can be utilized without departing from the spirit and scope of the claimed subject matter. Step 602 processes the data structures to produce pseudo-documents associated with the data structures. In the illustrated and described embodiment, each particular data structure can have a collection of pseudo-documents which represent a set of searchable objects for that particular data structure. Any suitable techniques can be utilized to produce the pseudo-documents. In at least some embodiments, the pseudo-documents can be created by conducting queries, such as SQL queries, against the data structures. Examples of how this can be done are provided above. Step 604 enables pseudo-documents to be searched. The step can be performed in any suitable way. For example, in at least some embodiments, the pseudo-documents can be stored in the database along with their associated data structures.

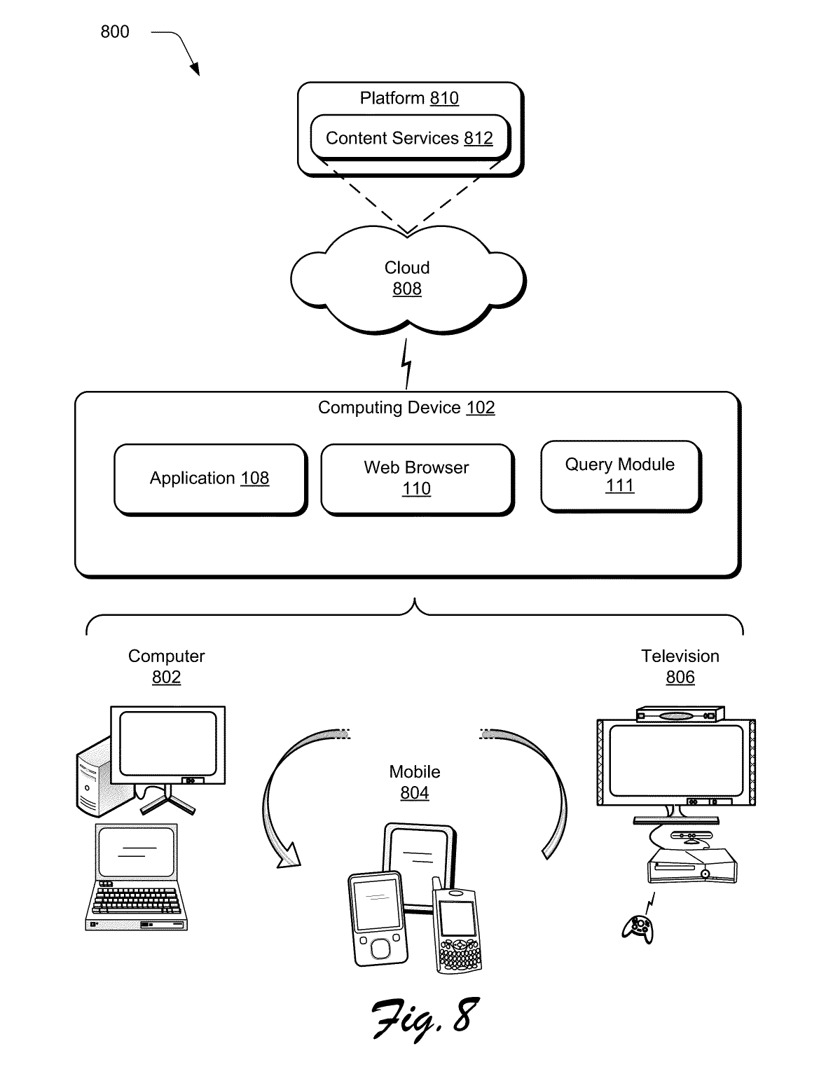

FIG. 7 is a flow diagram that describes steps in a method in which pseudo-documents can be used in accordance with one or more embodiments. The method can be implemented in connection with any suitable hardware, software, firmware, or combination thereof. In at least some embodiments, the method can be implemented by a suitably-configured search engine, such as one that might be associated with a web browser or other software executing on a computing device.

Step 700 receives a search term associated with a search. In the illustrated and described embodiment, the search term can comprise a text string such as a word or words that are to be used in a query. Step 702 searches collections of pseudo-documents using the search term. In the illustrated and described embodiment, the search term can be utilized to search an indexed collection of pseudo-documents. Step 704 identifies one or more data structures associated with collections of pseudo-documents that are returned by the search. Based on the identification of the data structures, decisions can now be made as to the pertinence of a particular data structure relative to the search term received at step 700.

Having considered various embodiments and methods, consider now an example system and device that can be utilized to implement the embodiments described above.

Example System and Device

FIG. 8 illustrates an example system 800 that includes the computing device 102 as described with reference to FIG. 1. The example system 800 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 800, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link. In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 102 may assume a variety of different configurations, such as for computer 802, mobile 804, and television 806 uses. Each of these configurations includes devices that may have generally different constructs and capabilities, and thus the computing device 102 may be configured according to one or more of the different device classes. For instance, the computing device 102 may be implemented as the computer 802 class of a device that includes a personal computer, desktop computer, a multi-screen computer, laptop computer, netbook, and so on. Each of these different configurations may employ the techniques described herein, as illustrated through inclusion of the application(s) 108, Web browser 110, and query module 111.

The computing device 102 may also be implemented as the mobile 804 class of device that includes mobile devices, such as a mobile phone, portable music player, portable gaming device, a tablet computer, a multi-screen computer, and so on. The computing device 102 may also be implemented as the television 806 class of device that includes devices having or connected to generally larger screens in casual viewing environments. These devices include televisions, set-top boxes, gaming consoles, and so on. The techniques described herein may be supported by these various configurations of the computing device 102 and are not limited to the specific examples the techniques described herein.

The cloud 808 includes and/or is representative of a platform 810 for content services 812. The platform 810 can include multiple databases that are configured as described above to promote searchability of data structures. The platform 810 abstracts underlying functionality of hardware (e.g., servers) and software resources of the cloud 808. The content services 812 may include applications and/or data that can be utilized while computer processing is executed on servers that are remote from the computing device 102. Content services 812 can be provided as a service over the Internet and/or through a subscriber network, such as a cellular or Wi-Fi network.

The platform 810 may abstract resources and functions to connect the computing device 102 with other computing devices. The platform 810 may also serve to abstract scaling of resources to provide a corresponding level of scale to encountered demand for the content services 812 that are implemented via the platform 810. Accordingly, in an interconnected device embodiment, implementation of functionality described herein may be distributed throughout the system 800. For example, the functionality may be implemented in part on the computing device 102 as well as via the platform 810 that abstracts the functionality of the cloud 808.

FIG. 9 illustrates various components of an example device 900 that can be implemented as any type of computing device as described above to implement embodiments of the techniques described herein. Device 900 includes communication devices 902 that enable wired and/or wireless communication of device data 904 (e.g., received data, data that is being received, data scheduled for broadcast, data packets of the data, etc.). The device data 904 or other device content can include configuration settings of the device, media content stored on the device, and/or information associated with a user of the device. Media content stored on device 900 can include any type of audio, video, and/or image data. Device 900 includes one or more data inputs 906 via which any type of data, media content, and/or inputs can be received, such as user-selectable inputs, messages, music, television media content, recorded video content, and any other type of audio, video, and/or image data received from any content and/or data source.

Device 900 also includes communication interfaces 908 that can be implemented as any one or more of a serial and/or parallel interface, a wireless interface, any type of network interface, a modem, and as any other type of communication interface. The communication interfaces 908 provide a connection and/or communication links between device 900 and a communication network by which other electronic, computing, and communication devices communicate data with device 900.

Device 900 includes one or more processors 910 (e.g., any of microprocessors, controllers, and the like) which process various computer-executable instructions to control the operation of device 900 and to implement embodiments of the techniques described herein. Alternatively or in addition, device 900 can be implemented with any one or combination of hardware, firmware, or fixed logic circuitry that is implemented in connection with processing and control circuits which are generally identified at 912. Although not shown, device 900 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 900 also includes computer-readable media 914, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 900 can also include a mass storage media device 916.

Computer-readable media 914 provides data storage mechanisms to store the device data 904, as well as various device applications 918 and any other types of information and/or data related to operational aspects of device 900. For example, an operating system 920 can be maintained as a computer application with the computer-readable media 914 and executed on processors 910. The device applications 918 can include a device manager (e.g., a control application, software application, signal processing and control module, code that is native to a particular device, a hardware abstraction layer for a particular device, etc.). The device applications 918 also include any system components or modules to implement embodiments of the techniques described herein. In this example, the device applications 918 include an interface application 922 and an input/output module 924 that are shown as software modules and/or computer applications. The input/output module 924 is representative of software that is used to provide an interface with a device configured to capture inputs, such as a touchscreen, track pad, camera, microphone, and so on. Alternatively or in addition, the interface application 922 and the input/output module 924 can be implemented as hardware, software, firmware, or any combination thereof. Additionally, the input/output module 924 may be configured to support multiple input devices, such as separate devices to capture visual and audio inputs, respectively.

Device 900 also includes an audio and/or video input-output system 926 that provides audio data to an audio system 928 and/or provides video data to a display system 930. The audio system 928 and/or the display system 930 can include any devices that process, display, and/or otherwise render audio, video, and image data. Video signals and audio signals can be communicated from device 900 to an audio device and/or to a display device via an RF (radio frequency) link, S-video link, composite video link, component video link, DVI (digital video interface), analog audio connection, or other similar communication link. In an embodiment, the audio system 928 and/or the display system 930 are implemented as external components to device 900. Alternatively, the audio system 928 and/or the display system 930 are implemented as integrated components of example device 900.

### CONCLUSION

Various embodiments promote the discoverability of data that can be contained within a database. In one or more embodiments, data within a database is organized in a structure having a schema. The structure and data can be processed in a manner that renders one or more pseudo-documents each of which constitutes a sub-structure that can be indexed. Any suitable criteria can be used to process the structure and data of the database to create the pseudo-documents. In some embodiments, processing can include running queries, such as SQL queries, against the database or other function calls to produce the pseudo-documents.

Once produced and indexed, the pseudo-documents constitute a set of searchable objects each of which relationally points back to its associated structure within the database. Searches can now be performed against the pseudo-documents which, in turn, returns a set of search results. The set of search results can include multiple sub-sets of pseudo-documents, each sub-set of which is associated with a different structure.

Properties and characteristics of the multiple sub-sets of pseudo-documents can then be used to ascertain the relevance of their associated structures relative to the search that was performed to produce the sub-sets of pseudo-documents. Once the relevance is ascertained, one or more associated structures within the database or databases can be identified as being more likely to be of use to a particular search user.

Pseudo-documents can serve to abstract away the schemas of individual structures within the database and can promote easier, more simplified search paradigms to facilitate discovery of data within a database.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method comprising:
receiving data structures associated with data stored in a database;
processing the data structures to produce pseudo-documents that include information derived based on sub-structures of the data structures associated with data stored in the database, individual pseudo-documents including a pointer back to at least one associated data structure, the pseudo-documents including information that can be searched to identify associated data structures; and
enabling pseudo-documents to be searched.

2. The computer-implemented method of claim 1, wherein the data structures comprise tables.

3. The computer-implemented method of claim 1, wherein said processing comprises processing the data structures based, at least in part, on types of data comprising data of the database.

4. The computer-implemented method of claim 1, wherein said processing comprises processing the data structures based, at least in part, on content of the data within the data structures.

5. The computer-implemented method of claim 1, wherein said processing comprises processing the data structures based, at least in part, on output of searches that might be conducted on data of the data structure.

6. The computer-implemented method of claim 1, wherein said processing comprises processing the data structures based, at least in part, on likely or actual uses of the data.

7. The computer-implemented method of claim 1, wherein said processing comprises executing at least one query against the data structures.

8. The computer-implemented method of claim 1, wherein said enabling comprises indexing the pseudo-documents to produce one or more inverted indexes.

9. One or more computer readable storage media embodying computer readable instructions which, when executed, implement a method comprising:
receiving a search term associated with a search;
searching collections of pseudo-documents using the search term, individual pseudo-documents including information derived based on one or more sub-structures of at least one respective data structure, individual pseudo-documents including a pointer back to an associated data structure; and
identifying one or more data structures associated with pseudo-documents that are returned by said searching.

10. The one or more computer readable storage media of claim 9, wherein said identifying is performed, based at least in part, on a number of pseudo-documents that are returned for a particular data structure.

11. The one or more computer readable storage media of claim 9, wherein said identifying is performed, based at least in part, on text-based scoring of individual pseudo-documents based on said search term.

12. The one or more computer readable storage media of claim 9, wherein said identifying is performed, based at least in part, on static ranking that is utilized to calculate a score for individual pseudo-documents.

13. The one or more computer readable storage media of claim 9, wherein said identifying is performed, based at least in part, on particular patterns that might occur within the pseudo-documents.

14. The one or more computer readable storage media of claim 9, wherein said identifying is performed, based at least in part, on a ranking of pseudo-documents based upon their temporal importance to other pseudo-documents.

15. The one or more computer readable storage media of claim 9, wherein said identifying is performed, based at least in part, on frequency-based techniques that are utilized to rank pseudo-documents.

16. The one or more computer readable storage media of claim 9, wherein said identifying is performed, based at least in part, on two or more of the following:
a number of pseudo-documents that are returned for a particular data structure;
text-based scoring of individual pseudo-documents based on said search term;
static ranking that is utilized to calculate a score for individual pseudo-documents;
particular patterns that might occur within the pseudo-documents;
a ranking of pseudo-documents based upon their temporal importance to other pseudo-documents; or
frequency-based techniques that are utilized to rank pseudo-documents.

17. A system comprising:
one or more computer readable storage media;
code embodied on the one or more computer readable storage media including at least a data analyzer, the code and data analyzer being configured to implement a method comprising:
processing tables of a database to produce pseudo-documents associated with respective tables, individual pseudo-documents including information derived from one or more sub-structures of at least one associated table of the database and including a pointer back to the at least one associated table, the pseudo-documents including information that can be searched to identify associated tables; and
enabling the pseudo-documents to be searched.

18. The system of claim 17 further comprising:
receiving a search term associated with a search;
searching collections of pseudo-documents using the search term; and
identifying one or more tables associated with pseudo-documents that are returned by said searching.

19. The system of claim 18, wherein said identifying is performed, based at least in part, on one of the following:
a number of pseudo-documents that are returned for a particular data structure;
text-based scoring of individual pseudo-documents based on said search term;
static ranking that is utilized to calculate a score for individual pseudo-documents;
particular patterns that might occur within the pseudo-documents;
a ranking of pseudo-documents based upon their temporal importance to other pseudo-documents; or
frequency-based techniques that are utilized to rank pseudo-documents.

20. The system of claim 18, wherein said identifying is performed, based at least in part, on two or more of the following:
a number of pseudo-documents that are returned for a particular data structure;
text-based scoring of individual pseudo-documents based on said search term;
static ranking that is utilized to calculate a score for individual pseudo-documents;
particular patterns that might occur within the pseudo-documents;
a ranking of pseudo-documents based upon their temporal importance to other pseudo-documents; or
frequency-based techniques that are utilized to rank pseudo-documents.

21. One or more computer readable storage media embodying computer readable instructions which, when executed, implement a method comprising:
receiving data structures associated with data stored in a database;
processing the data structures to produce pseudo-documents that include information derived based on sub-structures of the data structures associated with data stored in the database, individual pseudo-documents including a pointer back to at least one associated data structure, the pseudo-documents including information that can be searched to identify associated data structures; and
enabling pseudo-documents to be searched.

22. The one or more computer readable storage media of claim 21, wherein said processing comprises processing the data structures based, at least in part, on output of searches that are likely to be conducted on data of the data structure.

23. The one or more computer readable storage media of claim 21, wherein at least some of the pseudo-documents include one or more of the sub-structures.

24. A computer-implemented method comprising:
receiving a search term associated with a search;
searching collections of pseudo-documents using the search term, individual pseudo-documents including information derived based on one or more sub-structures of at least one respective data structure, individual pseudo-documents including a pointer back to an associated data structure; and
identifying one or more data structures associated with pseudo-documents that are returned by said searching.

25. The computer-implemented method of claim 24, wherein at least some of the pseudo-documents include one or more of the sub-structures.

26. A system comprising:
one or more computer readable storage media;
code embodied on the one or more computer readable storage media and executable by the system to perform operations including:
receiving a search term associated with a search;
searching collections of pseudo-documents using the search term, individual pseudo-documents including information derived based on one or more sub-structures of at least one respective data structure, individual pseudo-documents including a pointer back to an associated data structure; and
identifying one or more data structures associated with pseudo-documents that are returned by said searching.

27. The system of claim 26, wherein at least some of the pseudo-documents include one or more of the sub-structures.
